(19) United States
(12) Patent Application Publication
(10) Pub. No.: US 2005/0012952 A1
(43) Pub. Date: Jan. 20, 2005

(54) Printing system supporting customer emulation and method thereof

(76) Inventor: Hon-Rok Woo, Bucheon-city (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/731,483

(22) Filed: Dec. 10, 2003

(30) Foreign Application Priority Data
Jul. 14, 2003 (KR) 2003-47915

(51) Int. Cl. G06F 15/00

(52) U.S. Cl. 358/1.13; 358/1.16

(57) ABSTRACT

A printing system supporting a customer emulation and a method thereof are provided. The printing system comprises a computer interface to receive the customer emulation which is defined by a customer and a predetermined printing command signal from an external computer, a printer memory to store at least one fixed emulation and the received customer emulation, and a printer control unit to determine an emulation mode of the printing command signal. If it is determined to be a customer emulation mode, a printer control unit generates an image based on the customer emulation stored in the printer memory. A printer application developer may program using instructions that are defined by himself to improve efficiency in developing a printer application.

### CROSS-REFERENCE TO RELATED APPLICATIONS

This application claims the priority of Korean Patent Application No. 2003-47915, filed Jul. 14, 2003 in the Korean Intellectual Property Office, the disclosure of which is incorporated herein by reference.

### BACKGROUND OF THE INVENTION

1. Field of the Invention

The present invention relates to a printing system supporting a customer emulation and a method thereof, and more specifically, to a printing system supporting a customer emulation and a method thereof that enables development of an efficient printer application by supporting an emulation defined by a printer application developer.

2. Description of the Related Art

Conventionally, a printer standard supports an upper and a lower case of alphabets, numbers and symbols, and enlarges them two times horizontally and vertically. Recently, in order to support diverse and colorful print outputs, various printing methods are used along with the printer standard according to manufactures. For this, an emulation serves a function to maintain a broader printing compatibility by supporting the printing methods of the various manufactures with respect to one printer. As an emulation mode, Printer Control Language (PCL), Graphics Display Interface (GDI), PostScript, and Epson are used.

FIG. 1 is a flow chart for showing a conventional printing method that uses a fixed emulation. Referring to FIG. 1, the printing system first receives a printing command from a computer which is a host of the printing system (S100). After receiving the printing command, the printing system determines which kind of the emulation mode of the printing mode is used (S110). Based on the determined emulation mode, a bitmap image is generated (S120) and the generated image is printed (S130).

For this, a printer application developer has to program, using a printer language specification provided by the existing emulation modes such as PCL, PostScript, GDI, and Epson. However, the printer language specification provided by the emulation contains excessively complicated instructions and functions. Hence, the developer has difficulty in programming an application with the existing emulation.

### SUMMARY OF THE INVENTION

Accordingly, an aspect of the present invention is to provide a printing system supporting a customer emulation and a method thereof which allows a printing application developer to write his own customer emulation based on an existing emulation, to store it in a memory of the printing system, and to easily program a printing program by using the customer emulation.

To accomplish the above aspect, the printing system according to the present invention includes a computer interface to receive the customer emulation which is defined by a customer and a predetermined printing command signal from an external computer, a printer memory to store at least one fixed emulation and the received customer emulation, and a printer control unit to determine an emulation mode of the printing command signal. If it is determined to be a customer emulation mode, a printer control unit generates an image based on the customer emulation stored in the printer memory.

If the printer control unit determines the emulation mode of the received printing command signal to be a fixed emulation mode, the printer control unit generates an image based on the fixed emulation stored in the computer memory. The printer control unit includes a print unit to print the generated image under the control of the printer control unit.

The fixed emulation is any one of Printer Control Language (PCL), Graphics Display Interface (GDI), Epson and PostScript. The customer emulation is configured with a newly-defined instruction which corresponds to an instruction that configures any one of the fixed emulations, and generated by a predetermined customer emulation generating program in the external computer.

The external computer comprises a computer memory to store a predetermined customer emulation generating program and the generated customer emulation, an I/O interface unit to communicate with an external device, and a computer control unit to control generation of the customer emulation using the printing command signal and the customer emulation generating program and to transfer the customer emulation to the external device through the I/O interface unit. Preferably, the external computer comprises a display unit to output the customer emulation generating program, and an external input unit to receive a customer input corresponding to the customer emulation generating program.

In the printing system which is pre-stored with at least one customer-defined fixed emulation, a customer emulation supporting method according to the present invention comprises the steps of receiving a customer emulation which is defined by a customer, storing the received customer emulation, and receiving a predetermined printing command signal and determining an emulation mode of the printing command signal, and if it is determined to be a customer emulation mode, generating an image based on the stored customer emulation. If the emulation mode of the printing command signal is determined to be a fixed emulation mode, a step of generating an image based on the fixed emulation is included.

The fixed emulation may be any one of Printer Control Language (PCL), Graphics Display Interface (GDI), Epson and PostScript. The customer emulation is configured with a newly-defined instruction corresponding to an instruction configuring any one of the fixed emulations, and generated by the predetermined customer emulation generating program in the external computer and transferred.

### BRIEF DESCRIPTION OF THE DRAWINGS

The above aspects, and other features and advantages of the present invention will become more apparent after reading the following detailed description when taken in conjunction with the drawings, in which:

FIG. 1 is a flow chart of a printing method using a conventional fixed emulation;

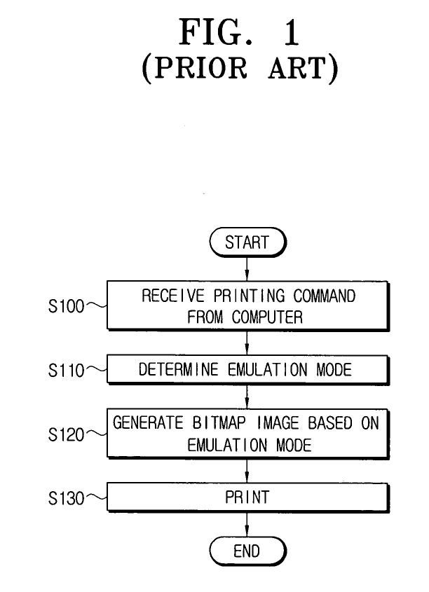

FIG. 2 is a block diagram of a printing system supporting a customer emulation according to an embodiment of the present invention;

FIG. 3 is a flow chart of a method supporting the customer emulation in the printing system according to an embodiment of the present invention; and

FIG. 4 is a diagram of a printer memory supporting the customer emulation and a method thereof according to an embodiment of the present invention.

### DETAILED DESCRIPTION OF THE PREFERRED EMBODIMENT

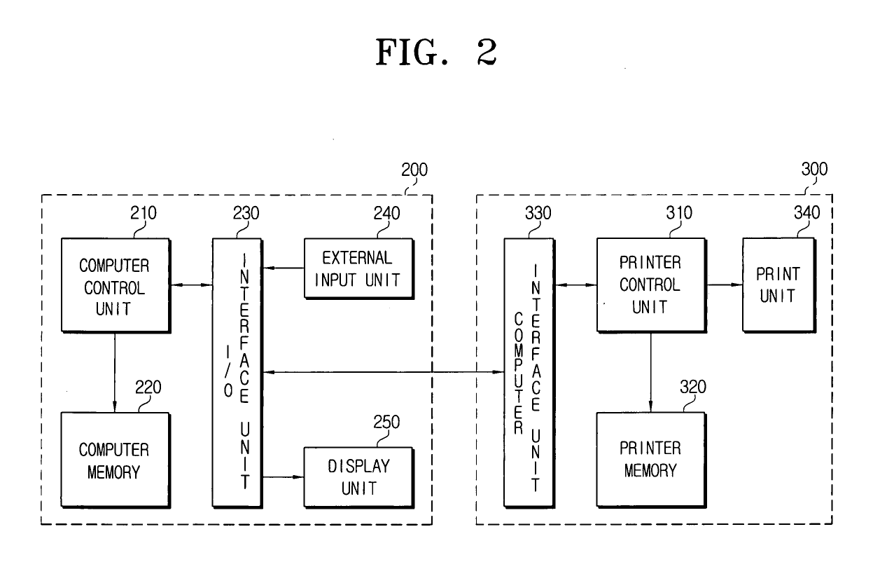

Hereinafter, the present invention will be apparent with reference to the attached drawings. FIG. 2 is a block diagram of a printing system supporting a customer emulation according to the present invention. In FIG. 2 are shown a printing system 300 and a computer 200 that serves as a host of the printing system 300. The printing system 300 comprises a printer control unit 310, a printer memory 320, a computer interface unit 330, and a print unit 340. The computer 200 comprises a computer control unit 210, a computer memory 220, an I/O interface unit 230, an external input unit 240, and a display unit 250.

At the computer 200 is installed a customer emulation generating program which is provided by a manufacturer of the printing system 300. The customer emulation generating program provides convenience in generating and storing the customer emulation in a printer memory 320 of the printing system 300. The display unit 250 displays a screen showing the executed customer emulation generating system. The external input unit 240 generates the customer emulation by using the emulation generating program through a key input. The computer memory 220 stores the generated customer emulation. In addition to generating the customer emulation in the host and storing it in the computer memory 220, it is also allowed to store a customer emulation generated in an external computer to the computer memory 220.

The computer control unit 210 transfers the customer emulation stored in the computer memory 220 to the printing system 300. Upon inputting of a key corresponding to a predetermined printing command signal from the external input unit 240, the computer control unit 210 transfers the printing command signal to the printing system 300.

The computer interface unit 330 of the printing system 300 receives the customer emulation or the printing command signal from the computer 200. The printer memory 320 stores the received customer emulation. The printer memory 320 stores more than one emulation which is initially provided by the manufacturer of the printing system 300.

Upon receiving the predetermined printing command signal from the computer 200, the printer control unit 310 determines an emulation mode of the command signal and generates an image based on the determination. In case of a customer emulation mode, the printer control unit 310 generates an image based on the customer emulation mode. In case of a general fixed emulation mode, the printer control unit 310 generates the image based on the general emulation mode. The print unit 340 prints the generated image.

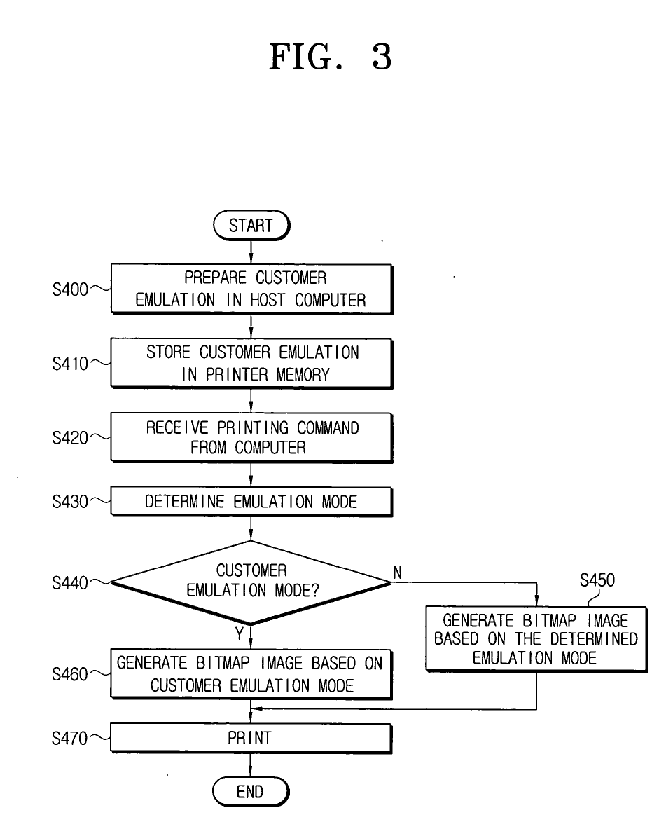

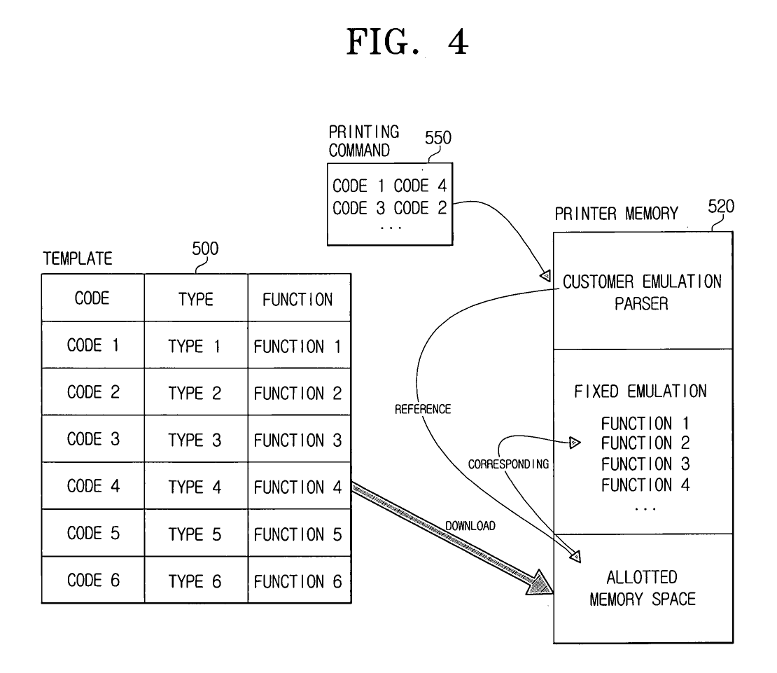

FIG. 3 is a flow chart of the method supporting the customer emulation in the printing system 300 according to the present invention. Referring to FIGS. 2 and 3, the computer 200, which is the host of the printing system 300, is prepared for the customer emulation (S400). Referring to FIG. 4, a template 500 is shown for generating the customer emulation. The template 500 of the FIG. 4 shows a screen of the executed customer emulation generating program that is provided by the manufacturer of the printing system 300. A function column of the template 500 indicates functions provided by the fixed emulation that has been installed in advance. Corresponding to the functions, a customer maps instructions to a code column and a type column. That is, the customer maps a customer-defined instruction to a fixed emulation instruction which is pre-stored. Hence, the customer experiences convenience when selecting the functions.

Table 1 is an example of the template 500 of FIG. 4 that is programmed by a printer application developer.

TABLE 1

| Code | Type | Function |
|---|---|---|
| *font | 1 | font (Roman, Gothic, Arial, Italic) |
| | | type: number, string |

According to the above template, “font 1” is recognized as a command to change a font to Roman. The customer emulation is stored in the computer memory 220 of the computer 200 and transferred to the printing system 300. On receiving the customer emulation, the printing system 300 stores it in the printer memory 320 (S410). As shown in FIG. 4, a printer memory 520_comprises a customer emulation parser to support the pre-stored fixed emulation and the customer emulation, and a memory space allotted to store the customer emulation. The printer memory 520 is an embodiment of the printer memory 320 according to the present invention. The customer emulation is stored in a space in the printer memory 520, which is allotted for the customer emulation.

The printing system 300 receives the printing command signal from the computer 200 (S420) and determines the emulation mode (S430). Next, the printing system 300 determines if the emulation mode is the customer emulation mode (S440).

If the determined emulation mode corresponds to any one of the fixed emulation modes that have been provided initially, a bitmap image is generated based on the corresponding fixed emulation mode (S450).

If the emulation mode is the customer emulation mode, a bitmap image is generated based on the customer emulation mode (S460). As shown in FIG. 4, if a signal according to the customer emulation is received along with a printing command 550, this is determined to be the customer emulation mode.

In response to the printing command corresponding to the customer emulation mode, the customer emulation parser of the printer memory 520 parses the command 550 according to the customer emulation into the customer emulation that is pre-stored in the step of S410. The customer emulation is based on the corresponding pre-stored fixed emulation. Accordingly, the command 550 corresponds to a mapped command of the fixed emulation, and a predetermined image is generated by executing the mapped command (S470).

For example, upon inputting of a code2 command which is defined in the template, it is determined to be the customer emulation and the parser parses the command into the customer emulation of the printer memory 520. The customer emulation executes a function 2 command corresponding to the fixed emulation and generates an image according to the function 2. Finally, the image generated in the step of S450 or S460 is printed.

As aforementioned, according to the present invention, the printer application developer may select and use names and types that are easy to understand with respect to the instructions which are frequently used, or quite complicated to use in developing a program, to thereby improve the efficiency of the application development.

While the preferred embodiment of the present invention has been described, additional variations and modifications in that embodiment may occur to those skilled in the art once they learn of the basic inventive concepts. Therefore, it is intended that the appended claims shall be construed to include both the preferred embodiment and all such variations and modifications as fall within the spirit and scope of the invention.

1. A printing system to support a customer emulation, comprising:
a computer interface to receive the customer emulation which is defined by a customer_and a predetermined printing command signal from an external computer;
a printer memory to store at least one fixed emulation and the received customer emulation; and
a printer control unit to determine an emulation mode of the printing command signal, and if it is determined to be a customer emulation mode, to generate an image based on the customer emulation stored in the printer memory.

2. The printing system of claim 1, wherein, if the printer control unit determines the emulation mode of the received printing command signal to be a fixed emulation mode, the printer control unit generates an image based on the fixed emulation stored in the computer memory.

3. The printing system of claim 1, further comprising a print unit to print the generated image under the control of the printer control unit.

4. The printing system of claim 1, wherein the customer emulation is configured with a newly-defined instruction which corresponds to an instruction that configures any one of the fixed emulations.

5. The printing system of claim 1, wherein the external computer comprises:
a computer memory to store a predetermined customer emulation generating program and the generated customer emulation;
an I/O interface unit to communicate with an external device; and
a computer control unit to control to generate the customer emulation using the printing command signal and the customer emulation generating program and to transfer the customer emulation to the external device through the I/O interface unit.

6. The printing system of claim 5, wherein the external computer comprises:
a display unit to output the customer emulation generating program; and
an external input unit to receive a customer input corresponding to the customer emulation generating program.

7. A customer emulation supporting method in a printing system which is pre-stored with at least one fixed emulation, comprising the steps of:
receiving a customer emulation which is defined by a customer;
storing the received customer emulation; and
receiving a predetermined printing command signal and determining an emulation mode of the printing command signal, and if it is determined to be a customer emulation mode, generating an image based on the stored customer emulation.

8. The method of claim 7, further comprising the step of, if the emulation mode of the printing command signal is determined to be a fixed emulation mode, generating an image based on the fixed emulation.

9. The method of claim 7, further comprising the step of printing the generated image.

10. The method of claim 7, wherein the customer emulation is configured with a newly-defined instruction corresponding to an instruction configuring any one of the fixed emulations.

11. The method of claim 7, wherein said receiving step for receiving a customer emulation comprises the step of mapping instructions for executing the customer emulation defined by the customer to at least one fixed emulation function, and said storing step comprises the step of storing at least one fixed emulation function in a template with the mapped instructions.

12. The method of claim 7, wherein said step of receiving a predetermined printing command generating an image based on the stored customer emulation comprises the step of parsing a predetermined command signal in a customer emulation mode to determine which pre-stored fixed emulations correspond thereto.
